(19) United States
(12) Patent Application Publication
(10) Pub. No.: US 2009/0294532 A1
(43) Pub. Date: Dec. 3, 2009

(54) ID issuing system and ID issuing server used therein

(75) Inventors: Kosuke Matsunaga, Oita-shi (JP); Koki Togashi, Matsumoto-shi (JP); Eiichi Tokonami, Oita-shi (JP); Minoru Ichimura, Shiojiri-shi (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 12/455,251

(22) Filed: May 29, 2009

(30) Foreign Application Priority Data
May 29, 2008 (JP) 2008-141031

(51) Int. Cl. G06F 19/00

(52) U.S. Cl. 235/385

(57) ABSTRACT

An ID issuing system that issues an ID in response to a request from a client includes: a plurality of ID issuing servers that execute issuance of the ID; and a history management device that manages the ID, which is issued by each of the plurality of ID issuing servers, by a history table. Either an issued state or a reserved state, which is a reserved but non-issued state, is registered as a status of an issuance history of the ID in the history table. Each of the plurality of ID issuing servers includes: a unit that registers an issuance history, in which the status is a reserved state, as an issuance history of an issue-wanted ID in the history table through the history management device before issuing the issue-wanted ID to the client in response to a request of the issue-wanted ID from the client; a unit that checks whether or not another issuance history different from the issuance history of the registered issue-wanted ID, which corresponds to the same ID as the issue-wanted ID, exists among issuance histories registered in the history table through the history management device regardless of the status; a unit that issues the issue-wanted ID and changes the status of the issuance history of the issue-wanted ID to an issued state through the history management device when another issuance history corresponding to the same ID as the issue-wanted ID does not exist; and a unit that stops issuing the issue-wanted ID when another issuance history corresponding to the same ID as the issue-wanted ID exists.

### CROSS REFERENCES TO RELATED APPLICATIONS

The entire disclosure of Japanese Patent Application No. 2008-141031, filed May. 29, 2008 is expressly incorporated by reference herein.

### BACKGROUND

1. Technical Field

The present invention relates to a technique capable of issuing an ID while preventing duplicate issuance.

2. Related Art

For a device manufactured in a certain company, an ID which does not duplicate is registered for every device manufactured in the company. For this reason, in an ID issuing system which issues an ID registered in each device, issued IDs are managed on the basis of the issuance history in order to prevent duplicate issuance.

For example, as disclosed in JP-A-2005-301483, a technique of using a lock mechanism of a database is used as a technique of preventing duplicate issuance when requests to issue a plurality of IDs occur simultaneously in the ID issuing system.

However, in case of using the lock mechanism, there was a possibility that the system might stop due to failure of the lock mechanism. Accordingly, it has been demanded to prevent the duplicate issuance using another technique in which the lock mechanism is not used.

### SUMMARY

An advantage of some aspects of the invention is to provide a technique capable of issuing an ID while preventing duplicate issuance.

The invention has been made to solve at least a part of the above-described problem and may be realized as the following forms or aspects.

According to a first aspect of the invention, an ID issuing system that issues an ID in response to a request from a client includes: a plurality of ID issuing servers that execute issuance of the ID; and a history management device that manages the ID, which is issued by each of the plurality of ID issuing servers, by a history table. Either an issued state or a reserved state, which is a reserved but non-issued state, is registered as a status of an issuance history of the ID in the history table. Each of the plurality of ID issuing servers registers an issuance history, in which the status is a reserved state, as an issuance history of an issue-wanted ID in the history table through the history management device before issuing the issue-wanted ID to the client in response to a request of the issue-wanted ID from the client, checks whether or not another issuance history different from the issuance history of the registered issue-wanted ID, which corresponds to the same ID as the issue-wanted ID, exists among issuance histories registered in the history table through the history management device regardless of the status, issuing the issue-wanted ID and changing the status of the issuance history of the issue-wanted ID to an issued state through the history management device when another issuance history corresponding to the same ID as the issue-wanted ID does not exist, and stopping issuing the issue-wanted ID when another issuance history corresponding to the same ID as the issue-wanted ID exists.

According to the ID issuing system, it is possible to issue an ID while preventing duplicate issuance of the ID without using a lock mechanism of a database.

According to a second aspect of the invention, preferably, in the ID issuing system according to the first aspect of the invention, registration of the issuance history of the issue-wanted ID into the history table is executed using, as table management keys, processing date and time acquired by reception of the request from the client and a processing ID for distinguishing issuance histories of the same processing date and time.

According to the ID issuing system, duplicate issuance of an ID can be easily prevented since the issuance history of the ID can be easily managed by the history table.

According to a third aspect of the invention, preferably, in the ID issuing system according to the second aspect of the invention, checking of another issuance history corresponding to the same ID as the issue-wanted ID is executed by checking whether or not there is an issuance history with the same table management keys.

According to the ID issuing system, duplicate issuance of an ID can be prevented by checking issuance histories registered in the history table.

According to a fourth aspect of the invention, preferably, in the ID issuing system according to the third aspect of the invention, checking of another issuance history corresponding to the same ID as the issue-wanted ID is executed by checking whether or not there is an issuance history, in which the same ID as the issue-wanted ID is included and the status is a reserved state, among existing issuance histories when the issuance histories with the same table management keys exist.

According to the ID issuing system, duplicate issuance of an ID can be prevented by checking issuance histories registered in the history table.

According to a fifth aspect of the invention, preferably, in the ID issuing system according to the fourth aspect of the invention, checking of another issuance history corresponding to the same ID as the issue-wanted ID is executed by checking whether or not an issuance history corresponding to the same ID as the issue-wanted ID exists among issuance histories with different table management keys when there is no issuance history in which the status is a reserved state.

According to the ID issuing system, duplicate issuance of an ID can be further prevented by checking issuance histories registered in the history table.

According to a sixth aspect of the invention, preferably, in the ID issuing system according to the third aspect of the invention, checking of another issuance history corresponding to the same ID as the issue-wanted ID is executed by checking whether or not an issuance history corresponding to the same ID as the issue-wanted ID exists among issuance histories with different table management keys when there is no issuance history with the same table management keys.

According to the ID issuing system, duplicate issuance of an ID can be further prevented by checking issuance histories registered in the history table.

According to a seventh aspect of the invention, preferably, in the ID issuing system according to the fifth or sixth aspect of the invention, in checking of another issuance history corresponding to the same ID as the issue-wanted ID, an issuance history with processing date and time, which is older than processing date and time of the issuance history of the issue-wanted ID by a predetermined amount, among issuance histories in which the status is a reserved state is excluded from objects to be checked.

According to the ID issuing system, since an issuance history with processing date and time older than processing date and time of the issuance history of the issue-wanted ID by a predetermined amount can be excluded from objects to be checked, useless ID issuance can be eliminated.

In addition, the invention does not necessarily need to include all of the various features described above, but some of them may be omitted or they may be combined appropriately. In addition, the invention may be realized in various forms. For example, the invention may be realized as an ID issuing system or a method thereof, an ID issuing server or a method thereof, a computer program for realizing the methods and a function of a system, and a recording medium having a computer program recorded therein. In each of the forms, the various additional components described previously may be applied.

In case of configuring the invention as a computer program or a recording medium having the program recorded therein, it may be configured as the whole program which controls an operation of a database access server or may be configured to include only portions for achieving the functions of the invention. Moreover, a flexible disk, a CD-ROM, a DVD-ROM, a magneto-optic disk, an IC card, a ROM cartridge, a punch card, a printed matter on which a reference numeral such as a bar code is printed, various computer-readable media such as an internal storage device (memory, such as a RAM or a ROM) and an external storage device of a computer may be used as recording media.

### BRIEF DESCRIPTION OF THE DRAWINGS

The invention will be described with reference to the accompanying drawings, wherein like numbers reference like elements.

FIG. 1 is an explanatory view illustrating an example of the configuration of an ID issuing system as an example of the invention.

FIG. 2 is an explanatory view illustrating the flow of ID issuing processing executed in a first AP server as an ID issuing server.

FIG. 3 is an explanatory view illustrating reservation status history registration processing executed in step S104 of FIG. 2.

FIGS. 4A to 4E are explanatory views illustrating examples of registration of a history table.

### DESCRIPTION OF EXEMPLARY EMBODIMENTS

Hereinafter, embodiments of the invention will be described in following order on the basis of examples.

A. Example

B. Modification.

### A. EXAMPLE

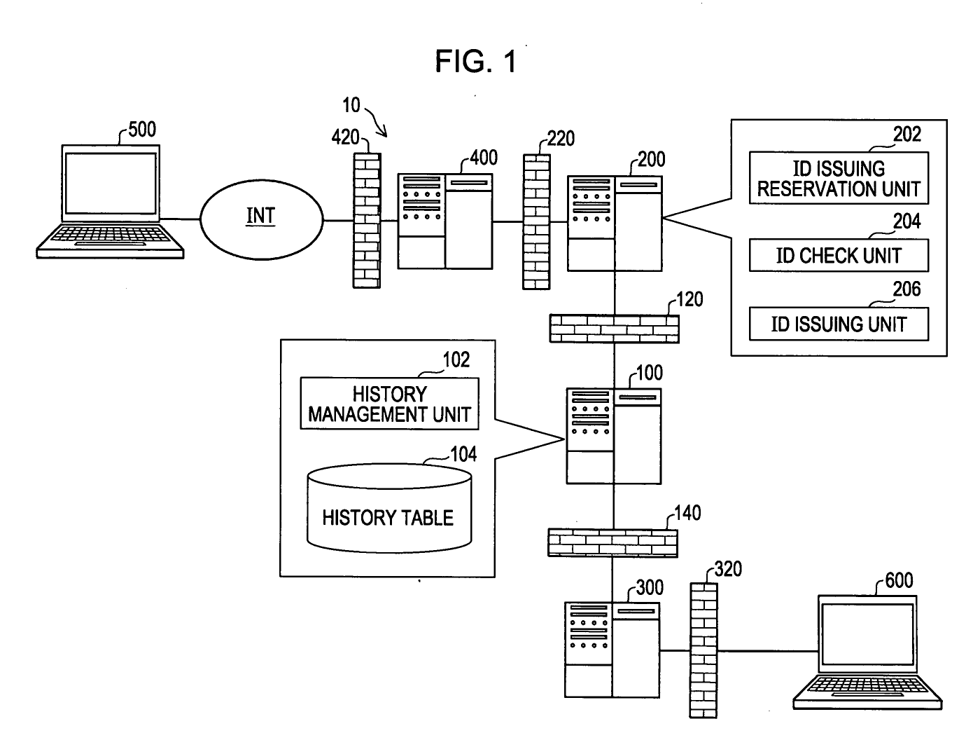

FIG. 1 is an explanatory view illustrating an example of the configuration of an ID issuing system 10 as an example of the invention. The ID issuing system 10 includes a database server 100 which manages the issuance history of IDs, AP servers 200 and 300 as ID issuing servers, and a Web server 400.

The database server 100 is connected to a first AP (application) server 200 with a firewall 120 interposed therebetween, and the first AP server 200 is connected to the Web server 400 with a firewall 220 interposed therebetween. In addition, the Web server 400 is connected to Internet INT with a firewall 420 interposed therebetween. A client 500 which requests issuance of an ID is connected to the Internet INT. The client 500 may request the first AP server 200 as an ID issuing server to issue an ID through the Internet INT and the Web server 400.

Moreover, although an example where only one client 500 is connected to the Internet INT is illustrated in the shown example, the invention is not limited thereto and the number of clients connected may be set arbitrarily.

In addition, the database server 100 is connected to a second AP server 300 with a firewall 140 interposed therebetween, and the second AP server 300 is connected to a client 600 with a firewall 320 interposed therebetween. The client 600 may request the second AP server 300 to issue an ID. Moreover, although an example where only one client 600 is connected to the second AP server 300 is illustrated in the shown example, the invention is not limited thereto and the number of clients connected may be set arbitrarily.

Moreover, in the ID issuing system 10 of the example shown, an example where one AP server connected to the Internet through a Web server and one AP server not connected to the Internet are provided is illustrated. However, the invention is not limited thereto, and the number of AP servers connected to the Internet and the number of AP servers not connected to the Internet may be set arbitrarily.

The ID issuance request from the first client 500 is made not to the first AP server 200 but to the Web server 400. In this case, when the Web server 400 receives the request from the first client 500, the Web server 400 transfers the request to the first AP server 200. In response to the received ID issuance request, the first AP server 200 determines whether or not the requested ID can be issued using a history table 104 managed in the database server 100 and executes issuance of the ID according to the determination result.

On the other hand, the ID issuance request from the second client 600 is made to the second AP server 300. In this case, when the second AP server 300 receives the request from the second client 600, the second AP server 300 determines whether or not the requested ID can be issued using a history table, which is managed in the database server 100, in response to the received ID issuance request and executes issuance of the ID according to the determination result, similar to the first AP server 200.

In addition, the above-described operation in the first AP server 200 is mainly executed by an ID issuing reservation unit 202, an ID check unit 204, and an ID issuing unit 206. The above-described operation in the second AP server 300 is the same as that of the first AP server 200 and is not shown in the drawing. Moreover, the above-described management operation using the history table 104 in the database server 100 is mainly executed by a history management unit 102. The database server 100 corresponds to a history management device of the invention.

In addition, examples of IDS issued in the ID issuing system 10 include not only a number or symbol given to every device of the same type manufactured in a company but also various identification codes, such as numbers issued in order of reception.

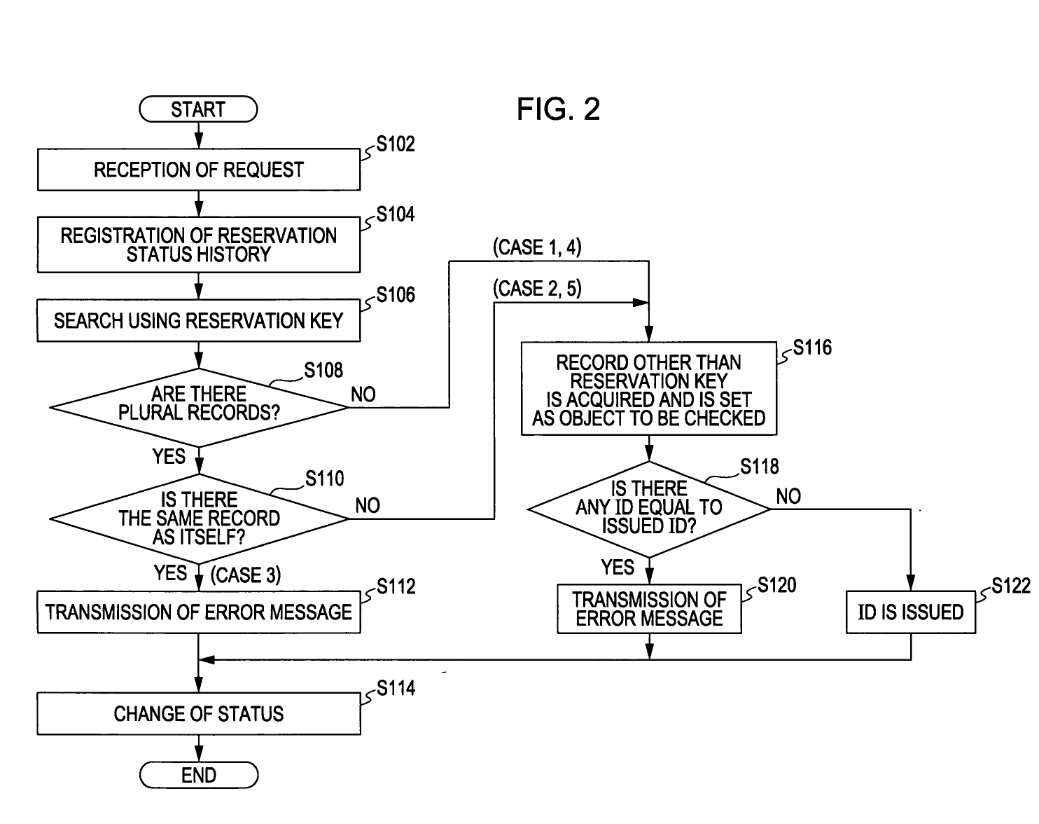

FIG. 2 is an explanatory view illustrating the flow of ID issuing processing executed in the first AP server 200 as an ID issuing server. In addition, ID issuing processing executed in the second AP server 300 as an ID issuing server is the same as ID issuing processing of the first AP server 200 described below.

First, the first AP server 200 receives a request of ID issuance from the first client 500, which was transferred from the Web server 400 (step S102). When this request is received, the ID issuing reservation unit 202 executes registration of an issuance history of an ID included in the request (hereinafter, referred to as an ‘issue-wanted ID’) into the history table 104 through the history management unit 102 of the database server 100 (step S104).

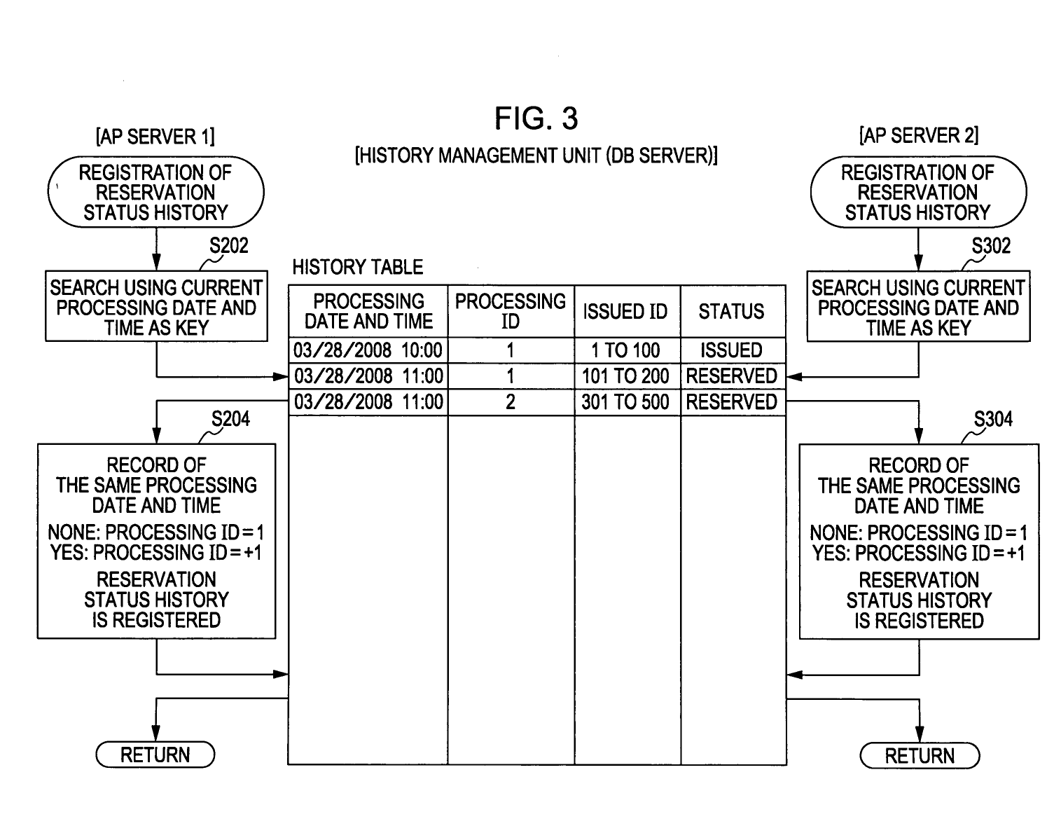

FIG. 3 is an explanatory view illustrating reservation status history registration processing executed in step S104 of FIG. 2. First, in step S202, the ID issuing reservation unit 202 of the first AP server 200 (AP server 1) executes search of the history table 104 through the history management unit 102 of the database server 100 using current date and time (current processing date and time), at which processing was started, as a search key, thereby checking whether or not there is a record of issuance history of the same processing date and time.

Then, in step S204, when there is no record of issuance history of the same processing date and time, ‘processing ID=1’ is set as an issued ID for registering the contents of the issue-wanted ID and registers an issuance history, in which the status is set as a reserved state, in the history table 104 through the history management unit 102. On the other hand, in step S204, when there is a record of issuance history of the same processing date and time, an issuance history is registered in the history table 104 in a state where a value, which is obtained by adding 1 to a processing ID of a largest value of existing records of the issuance history, is set as a value of the processing ID (step S204). For example, as shown in the history table 104 of FIG. 3, assuming that current processing date and time are ‘2008/03/28’, the issuance history is registered in the history table 104 with a value of the processing ID as ‘2’ if there is a record of issuance history in which the processing ID at processing date and time of ‘2008/03/28’ is ‘1’.

In addition, the second AP server 300 also executes processing of reservation status history registration by executing processing shown in steps S302 and S304 independently of the first AP server 200 and similar to the first AP server 200.

After registering the issuance history of the issue-wanted ID as a reservation status as described above, the ID check unit 204 executes search of the history table 104 by combination (hereinafter, referred to as a ‘reservation key’) of the processing ID and processing date and time of issuance history of the registered issue-wanted ID through the history management unit 102 in step S106 of FIG. 2. Then, in step S108, it is checked whether or not there are two or more records of the issuance history of the combination of the processing date and time and the processing ID equal to the reservation key. When there are records of a plurality of issuance histories of the same processing date and time and processing ID, it is checked whether or not there is a record of an issuance history, in which the same issued ID as the issue-wanted ID is registered, among the records in step S110.

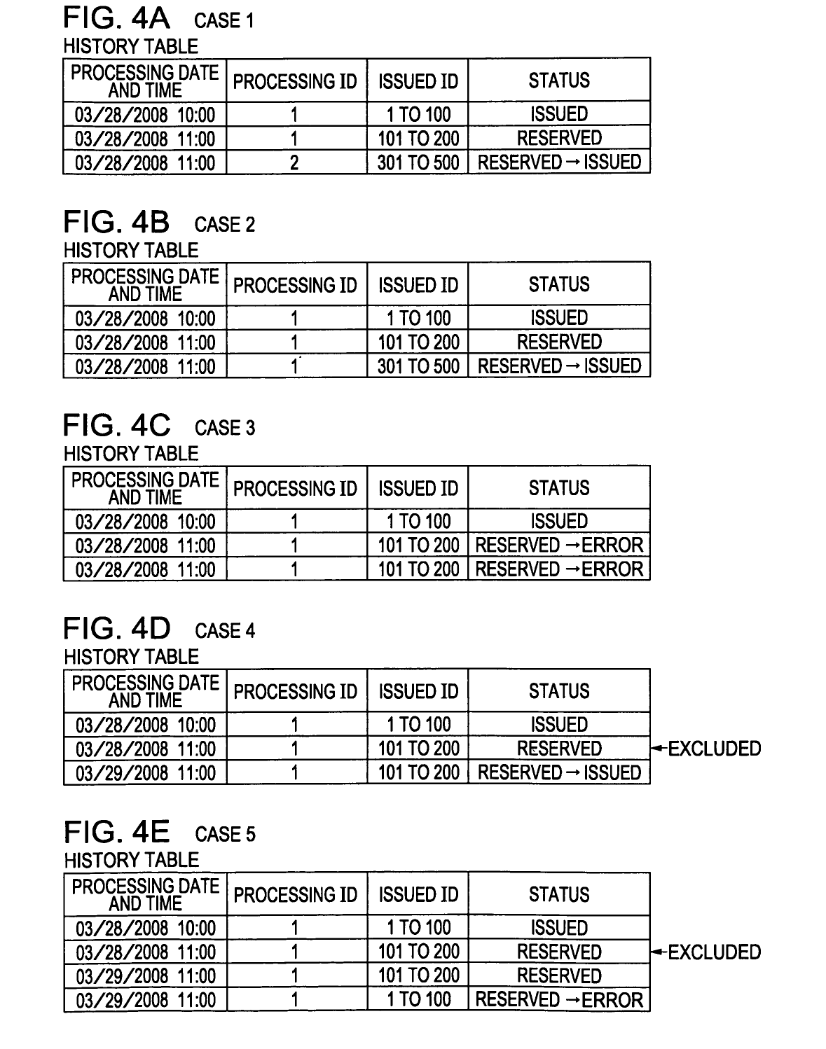

When there is a record of an issuance history in which the same issued ID as the issue-wanted ID is registered, for example, when the history table 104 is like a case 3 shown in FIG. 4C, the ID issuing unit 206 transmits an error message to the client 500 through the Web server 400 in step S112 and changes statuses of the issuance history of the issue-wanted ID and the issuance history of the reservation status, in which the same issued ID is registered, to error statuses through the history management unit 102 in step S114, completing a series of processing.

On the other hand, when there is no record of issuance history of the same processing date and time and processing ID as the reservation key, for example, when the history table 104 is like a case 1 shown in FIG. 4A or a case 4 shown in FIG. 4D, or when there is a record of issuance history of the same processing date and time and processing ID as the reservation key but there is no record of issuance history with the same contents, for example, when the history table 104 is like a case 2 shown in FIG. 4B or a case 5 shown in FIG. 4E, processing of steps S116 to S122 and S114 is executed.

In step S116, the ID check unit 204 acquires a record of an issuance history of the combination of processing date and time and processing ID different from the reservation key (simply referred to as ‘except a reservation key’) from the history table 104 through the history management unit 102 and sets it as an object to be checked. However, an issuance history with a reservation status of date and time older than processing date and time of an issue-wanted ID by a predetermined time, for example, about 10 minutes is excluded. For example, in the case 4 shown in FIG. 4D or the case 5 shown in FIG. 4E, assuming that processing date and time of an issue-wanted ID are ‘2008/03/29 11:00’, an issuance history of a reservation status with processing date and time of ‘2008/03/28 11:00’ is excluded. Moreover, the predetermined time is a time set to exclude an issuance history with a reservation status due to stopping of processing during a processing operation, and may be set appropriately.

Then, in step S118, it is checked whether or not there is an issuance history, in which the same issued ID as the issue-wanted ID is registered, in records of the issuance history to be checked acquired in step S116.

When there is an issuance history in which the same issued ID is registered, for example, in the case 5 shown in FIG. 4E, assuming that the issuance history in which issued IDs at processing date and time of ‘2008/03/29 11:00’ are ‘1-100’ is an issuance history of the issue-wanted ID, the issued IDs duplicate with issued IDs of an issuance history with an issued status. In this case, the ID issuing unit 206 transmits an error message to the client 500 through the Web server 400 in step S120 and changes statuses of the issuance history of the issue-wanted ID and the issuance history of the reservation status, in which the same issued ID is registered, to error statuses through the history management unit 102 in step S114, completing a series of processing.

On the other hand, when there is no issuance history in which the same issued ID is registered, for example, in the case 1 shown in FIG. 4A, the case 2 shown in FIG. 4B, or the case 4 shown in FIG. 4D, the ID issuing unit 206 issues the requested issue-wanted ID to the client 500 through the Web server 400 in step S122 and changes the status of the corresponding issuance history from the reservation status to the issued status through the history management unit 102 in step S114, completing a series of processing.

As described above, in the ID issuing system 10 of this example, the first AP server 200 as an ID issuing server registers an issuance history with a reservation status in the history table 104 through the history management unit 102 of the database server 100 in response to the request of ID issuance from the client 500, and then checks whether or not an issuance history, in which the same issued ID as the issue-wanted ID is registered, is registered in the history table regardless of an issuance history with a reservation status or an issuance history with an issued status. Then, when there is an issuance history in which the same issued ID as the issue-wanted ID is registered, the ID issuing processing can be completed by changing a status of an issuance history with a reservation status, among the issuance history of the issue-wanted ID and the corresponding issuance history, to an error status. Then, when there is no issuance history in which the same issued ID as the issue-wanted ID is registered, the ID issuing processing can be completed by executing processing for issuing the issue-wanted ID and changing a status of an issuance history of the issue-wanted ID to an issued status. Furthermore, in response to the request of ID issuance from the client 600, the second AP server 300 can execute the same processing as the first AP server 200 completely independently of the first AP server 200. Accordingly, even if requests of issuance of the same ID occur simultaneously in the first and second AP servers 200 and 300, duplicate issuance can be prevented.

In addition, issuance of an ID can be executed by transmitting an error for the requests of issuance of the same ID in order to end the ID issuing processing and executing the request of ID issuance again in either one side.

Furthermore, an issuance history which remains in a reservation status in the history table 104 since processing thereof has not been completed due to occurrence of certain failure, such as occurrence of failure in the database server 100, during ID issuing processing can be excluded from an object to determine ID duplication. Therefore, useless ID issuance can be eliminated.

### B. Modification

In addition, the invention is not limited to the above-described example or embodiment, but various modifications may be made within the scope without departing from the subject matter or spirit of the invention.

In the above-described example, a configuration where the issuance history, which remains in the reservation status in the history table 104 since processing thereof has not been completed due to occurrence of certain failure during ID issuing processing, is excluded from the object to determine ID duplication is adopted. However, the issuance history does not necessarily need to be excluded.

What is claimed is:

1. An ID issuing system that issues an ID in response to a request from a client, comprising:
a plurality of ID issuing servers that execute issuance of the ID; and
a history management device that manages the ID, which is issued by each of the plurality of ID issuing servers, by a history table,
wherein either an issued state or a reserved state, which is a reserved but non-issued state, is registered as a status of an issuance history of the ID in the history table, and
each of the plurality of ID issuing servers includes:
a unit that registers an issuance history, in which the status is a reserved state, as an issuance history of an issue-wanted ID in the history table through the history management device before issuing the issue-wanted ID to the client in response to a request of the issue-wanted ID from the client;
a unit that checks whether or not another issuance history different from the issuance history of the registered issue-wanted ID, which corresponds to the same ID as the issue-wanted ID, exists among issuance histories registered in the history table through the history management device regardless of the status;
a unit that issues the issue-wanted ID and changes the status of the issuance history of the issue-wanted ID to an issued state through the history management device when another issuance history corresponding to the same ID as the issue-wanted ID does not exist; and
a unit that stops issuing the issue-wanted ID when another issuance history corresponding to the same ID as the issue-wanted ID exists.

2. The ID issuing system according to claim 1,
wherein registration of the issuance history of the issue-wanted ID into the history table is executed using, as table management keys, processing date and time acquired by reception of the request from the client and a processing ID for distinguishing issuance histories of the same processing date and time.

3. The ID issuing system according to claim 2,
wherein checking of another issuance history corresponding to the same ID as the issue-wanted ID is executed by checking whether or not there is an issuance history with the same table management keys.

4. The ID issuing system according to claim 3,
wherein checking of another issuance history corresponding to the same ID as the issue-wanted ID is executed by checking whether or not there is an issuance history, in which the same ID as the issue-wanted ID is included and the status is a reserved state, among existing issuance histories when the issuance histories with the same table management keys exist.

5. The ID issuing system according to claim 4,
wherein checking of another issuance history corresponding to the same ID as the issue-wanted ID is executed by checking whether or not an issuance history corresponding to the same ID as the issue-wanted ID exists among issuance histories with different table management keys when there is no issuance history in which the status is a reserved state.

6. The ID issuing system according to claim 3,
wherein checking of another issuance history corresponding to the same ID as the issue-wanted ID is executed by checking whether or not an issuance history corresponding to the same ID as the issue-wanted ID exists among issuance histories with different table management keys when there is no issuance history with the same table management keys.

7. The ID issuing system according to claim 5,
wherein in checking of another issuance history corresponding to the same ID as the issue-wanted ID, an issuance history with processing date and time, which is older than processing date and time of the issuance history of the issue-wanted ID by a predetermined amount, among issuance histories in which the status is a reserved state is excluded from objects to be checked.

8. An ID issuing server that issues an ID in response to a request from a client using a history table in which either an issued state or a reserved state, which is a reserved but non-issued state, is registered as a status of an issuance history of an ID, comprising:
a unit that registers an issuance history, in which the status is a reserved state, as an issuance history of an issue-wanted ID in the history table before issuing the issue-wanted ID to the client in response to a request of the issue-wanted ID from the client;
a unit that checks whether or not another issuance history different from the issuance history of the registered issue-wanted ID, which corresponds to the same ID as the issue-wanted ID, exists among issuance histories registered in the history table regardless of the status;
a unit that issues the issue-wanted ID and changes the status of the issuance history of the issue-wanted ID to an issued state when another issuance history corresponding to the same ID as the issue-wanted ID does not exist; and
a unit that stops issuing the issue-wanted ID when another issuance history corresponding to the same ID as the issue-wanted ID exists.

9. A method of issuing a specific ID in response to a request from a client using a history table in which either an issued state or a reserved state, which is a reserved but non-issued state, is registered as a status of an issuance history of an ID, comprising:
registering an issuance history, in which the status is a reserved state, as an issuance history of an issue-wanted ID in the history table before issuing the issue-wanted ID to the client in response to a request from the client;
checking whether or not another issuance history different from the issuance history of the registered issue-wanted ID, which corresponds to the same ID as the issue-wanted ID, exists among issuance histories registered in the history table regardless of the status;
issuing the issue-wanted ID and changing the status of the issuance history of the issue-wanted ID to an issued state when another issuance history corresponding to the same ID as the issue-wanted ID does not exist; and
stopping issuing the issue-wanted ID when another issuance history corresponding to the same ID as the issue-wanted ID exists.
